(19) United States
(12) Patent Application Publication
(10) Pub. No.: US 2007/0023604 A1
(43) Pub. Date: Feb. 1, 2007

(54) Slide seat adjusting device

(76) Inventor: Ching-Hai Chou, Taichung City (TW)

Correspondence Address: CHARLES E. BAXLEY, ESQ., 90 JOHN STREET, THIRD FLOOR, NEW YORK, NY, 10038, US

(21) Appl. No.: 11/190,521

(22) Filed: Jul. 28, 2005

(51) Int. Cl. F16M 13/00

(52) U.S. Cl. 248/424

(57) ABSTRACT

A slide seat adjusting device for adjusting positional relation between a slide seat and a base, comprises a pair of identical adjusting blocks each having an abutting surface and a slant surface opposite the abutting surface. The slant surfaces of the pair of adjusting blocks abut against each other and have identical gradient values, the pair of adjusting blocks are slideably disposed between the slide seat and the base, the abutting surface of one of the pair of adjusting blocks abuts against the slide seat in a surface-to-surface manner, the abutting surface of another one of the pair of adjusting blocks abuts against the base in a surface-to-surface manner, and the abutting surfaces of the pair of adjusting blocks are parallel to each other.

### BACKGROUND OF THE INVENTION

1. Field of the Invention

The present invention relates to an adjusting device, and more particularly to a high precision slide seat adjusting device for adjusting the positional relation between the slide seat and the base.

2. Description of the Prior Art

Normally a slide seat is slideably disposed on a base, and to enable the slide seat to slide smoothly relative to the base, a slide seat adjusting device is needed to adjust the slide seat properly, enabling the positional relation between the slide seat and the base work to be adjusted to an optimum level.

As shown in FIG. 1, a conventional slide seat adjusting device generally comprises an adjusting block 11 and a plurality of screws 12. The adjusting block 11 has a rectangular shape and is disposed between a slide seat 13 and a base 14. Two opposite surfaces of the adjusting block 11 keep contacting the slide seat 13 and the base 14 in a surface-to-surface contact manner. The respective screws 12 are screwed in the base 14 in such a manner that the head of the respective screws 12 presses against the surface of the slide seat 13 while the end of the screws 12 protrudes out of the base 14 and is to be rotated by the user. The adjusting block 11 will be moved slightly by adjusting the respective adjusting screws 12, thus enabling the positional relation between the slide seat 13 and the base 14 to be adjusted to an optimum condition. However, the adjustment must be performed by a skilled professional, once the respective screws 12 are adjusted differently, the adjustment value of the adjusting block 11 will inevitably be affected, leading to an opposite result.

To overcome this defect, as shown in FIG. 2, a trapeziform adjusting block 23 is disposed between the base 22 and the slide seat 21 in such a manner that the slant surface 231 of the adjusting block 23 contacts the base 22 while a horizontal surface 232 of the adjusting block 23 contacts the slide seat 21. In addition, between the slide seat 21 and the base 22 is arranged an adjusting screw 24. By adjusting the adjusting screw 24 along the direction of the slide seat 21, the slide seat 21 and the base 22 can be adjusted to an optimum condition, therefore, this adjustment can be done by an ordinary people without skill. However, it still has some shortcomings:

First, the adjusting block 23 and the slide seat 21 are two independent structures contacting each other via the slant surface and are made separately in different batches, so that the gradient value of the slant surface of the adjusting block 23 is difficult to be controlled, as a result, the contact accuracy between the adjusting block 23 and the slide seat 21 will be affected adversely.

Second, in order to maintain an ideal contact, the adjusting block 23 and the slide seat 21 always need to be adjusted for several times otherwise they can't reach an optimum condition. Therefore, producing such an adjusting block 23 is really troublesome and time-consuming.

The present invention has arisen to mitigate and/or obviate the afore-described disadvantages.

### SUMMARY OF THE INVENTION

The primary objective of the present invention is to provide a high precision slide seat adjusting device which is capable of simplifying the adjustment process of slide seat.

The secondary of the present invention is to provide a high precision slide seat adjusting device that can make the slide seat production much easier.

A slide seat adjusting device for adjusting positional relation between a slide seat and a base, comprises a pair of identical adjusting blocks each having an abutting surface and a slant surface opposite the abutting surface. The slant surfaces of the pair of adjusting blocks abut against each other and have identical gradient values, the pair of adjusting blocks are slideably disposed between the slide seat and the base, the abutting surface of one of the pair of adjusting blocks abuts against the slide seat in a surface-to-surface manner, the abutting surface of another one of the pair of adjusting blocks abuts against the base in a surface-to-surface manner, and the abutting surfaces of the pair of adjusting blocks are parallel to each other.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a cross sectional view of a conventional slide seat adjusting device;

FIG. 2 is a cross sectional view of another conventional slide seat adjusting device;

FIG. 3 is an exploded view of a slide seat adjusting device in accordance with the present invention;

FIG. 4 is an assembly view of the slide seat adjusting device in accordance with the present invention;

FIG. 5 is a cross sectional view of the slide seat adjusting device in accordance with the present invention;

FIG. 6 is an enlarged view of a part of the slide seat adjusting device in accordance with the present invention;

FIG. 7 shows that of the slide seat adjusting device in accordance with the present invention after adjustment;

FIG. 8 is an operative view of showing that both of the adjusting blocks are being adjusted.

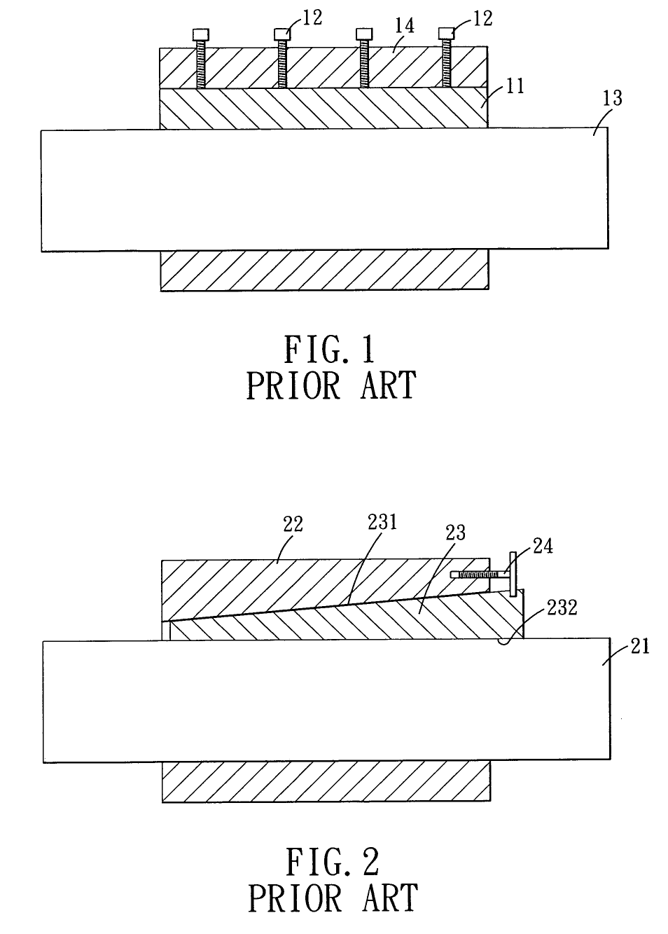

### DETAILED DESCRIPTION OF THE PREFERRED EMBODIMENT

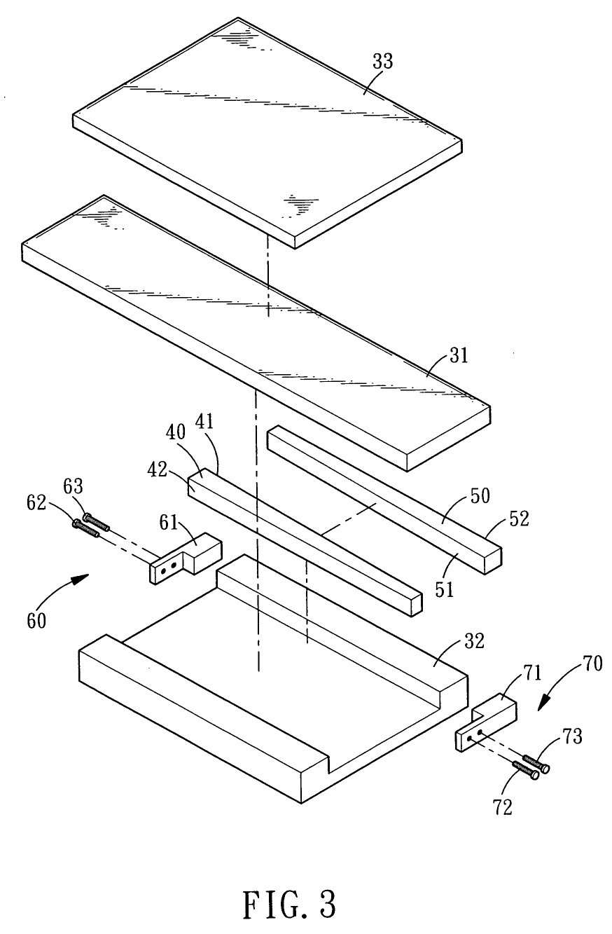

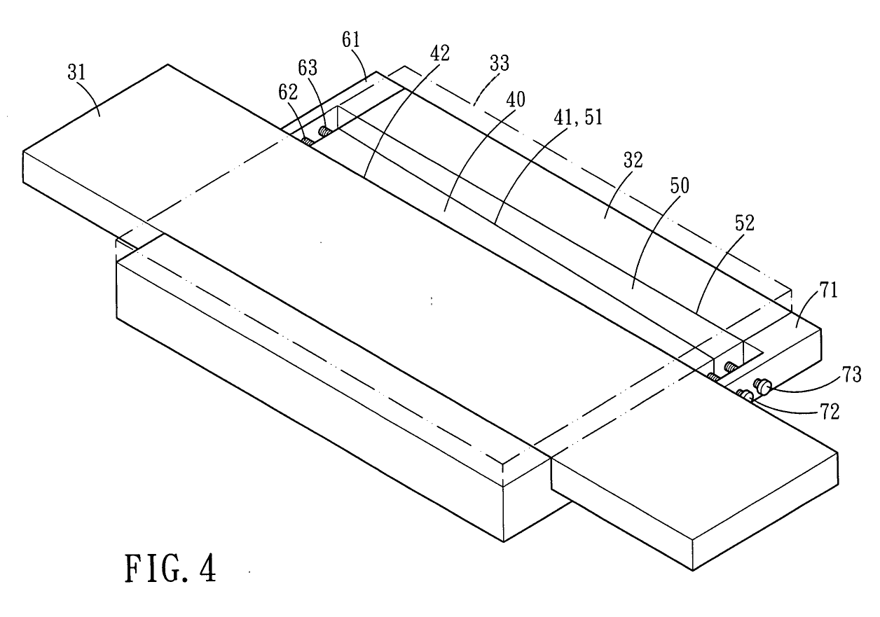

Referring to FIGS. 3, 4 and 5, a slide seat adjusting device in accordance with the present invention is shown and used to adjust the relation between the slide seat 31 and the base 32. The base 32 is formed with a slide groove 321 in which the slide seat 31 is moveably disposed, and a side of the slide seat 31 contacts the sidewall of the slide groove 321 in a surface to surface, a teeth-to-teeth or other contact manners. In addition, the slide seat 31 is covered with a cover 33 after being assembled to the base 32. The slide seat adjusting comprises a first adjusting block 40 and second adjusting blocks 50 that are identical in structure and are adjusted by two adjusting assemblies 60 and 70, respectively.

The first adjusting block 40 is a trapezoid structure having a slant surface 41 and an abutting surface 42 and is slidebly dispose between the slide seat 31 and the base 32 in such a manner that the abutting surface 42 contacts the sidewall of the slide seat 31 in a surface-to-surface contact.

The second adjusting block 50 is also a trapezoid structure having a slant surface 51 and an abutting surface 52 and is slideably disposed between the slide seat 31 and the base 32 in such a manner that the abutting surface 52 contacts another sidewall of the slide seat 31 in a surface-to-surface contact. And the slant surface 51 contacts the slant surface 41, so that the abutting surface 52 is parallel to the abutting surface 42. The gradient of the slant surface 51 is the same as that of the slant surface 41 of the first adjusting block 40.

The two adjusting assemblies 60 and 70 each comprise a positioning block 61, 71 and two screws 62, 63, 72, 73. The positioning blocks 61 and 71 are fixed at both ends of the base 32, and the screws 62, 63, 72 and 73 are adjustably screwed in the positioning blocks 61 and 71 and are employed to adjust the first and second adjusting blocks 40 and 50 by pushing the end thereof.

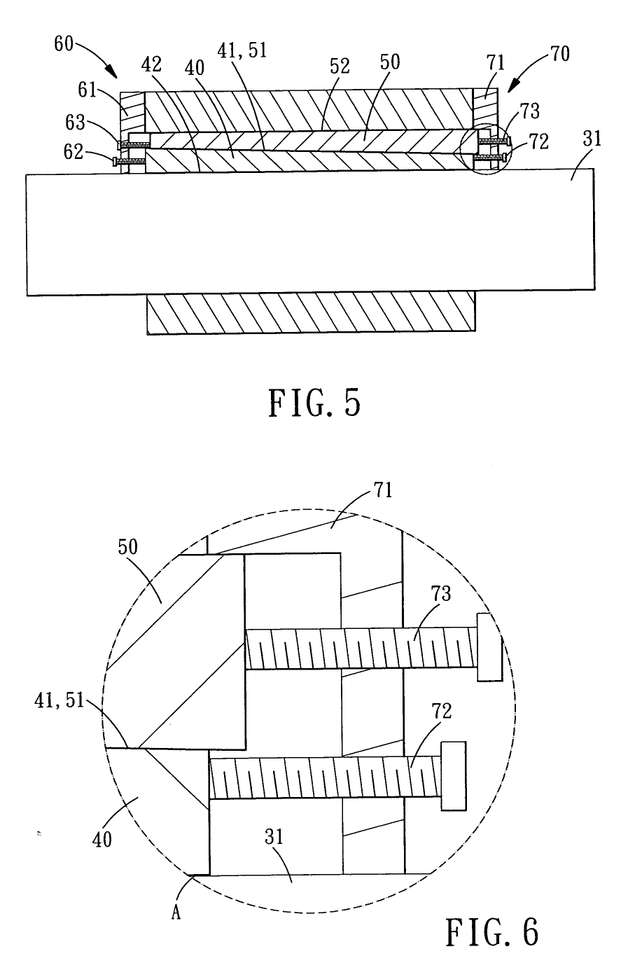

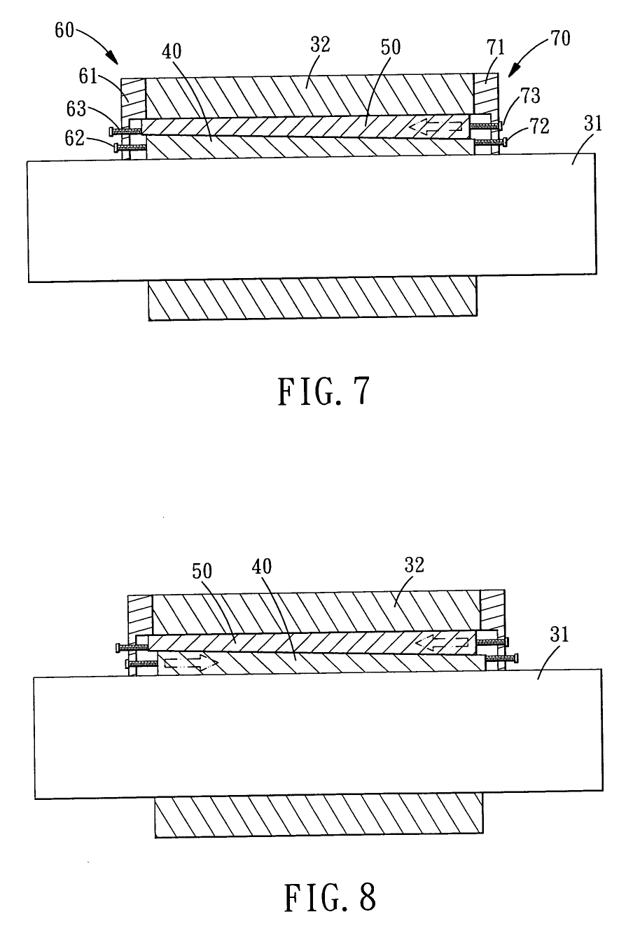

For a better understanding of the present invention, references should be made to FIGS. 5-7, to maintain an optimum relation between the slide seat 31 and the base 32, namely, to eliminate the clearance A between the slide seat 31 and the base 32, one of the screws 63 and 73 should be unscrewed initially. The screws 63 and 73 are used to push against both ends of the same adjusting block 50 for example. And then the user can adjust the screw 73 so as to move the second adjusting block 50 in the sliding direction of the slide seat 31, and the second adjusting block 50 will push the first adjusting block 40 to make it move in a parallel fashion, thus increasing the distance between the abutting surfaces 42 and 52 of the first and second adjusting blocks 40 and 50, and accordingly enabling the slide seat 31 and the base 32 to be assembled in an optimum condition. Therefore, the slide seat adjusting device of the present invention can be adjusted easily by an ordinary people without any skills.

On the other hand, the first and second adjusting blocks are identical in structure, so that they are interchangeable and can be produced simultaneously with the same equipment. The interchangeability further brings rapid assembly, and after assembly, the slant surfaces of the first and second adjusting blocks can abut against each other tightly, and the abutting surfaces of the first and second adjusting blocks will parallel to each other.

The first and second adjusting blocks are identical in structure, the gradient values of their slant surfaces can be adjusted according to needs, as long as the gradient values are equal and their abutting surfaces are parallel to each other after adjustment.

Referring finally to FIG. 8, between the base 32 and the slide seat 31 are arranged with the first and second identical adjusting blocks 40 and 50, plus the first and second adjusting blocks 40 and 50 are both adjustable, so that the slide seat adjusting device can be adjusted bidirectionally, and the adjustment allowance thereof is doubled.

While we have shown and described various embodiments in accordance with the present invention, it should be clear to those skilled in the art that further embodiments may be made without departing from the scope of the present invention.

What is claimed is:

1. A slide seat adjusting device for adjusting positional relation between a slide seat and a base, comprising:
a pair of identical adjusting blocks each having an abutting surface and a slant surface opposite the abutting surface, wherein the slant surfaces of the pair of adjusting blocks abut against each other and have identical gradient values, the pair of adjusting blocks are slideably disposed between the slide seat and the base, the abutting surface of one of the pair of adjusting blocks abuts against the slide seat in a surface-to-surface manner, the abutting surface of another one of the pair of adjusting blocks abuts against the base in a surface-to-surface manner, and the abutting surfaces of the pair of adjusting blocks are parallel to each other.
